(19) United States
(12) Patent Application Publication
(10) Pub. No.: US 2023/0195579 A1
(43) Pub. Date: Jun. 22, 2023

(54) Peer Recovery From Remote Storage

(71) Applicant: Elasticsearch B.V., Mountain View, CA (US)

(72) Inventors: Matthew Lee Hinman, Aurora, CO (US); Jason Tedor, Avon, OH (US); Henning Andersen, Midtjylland (DK); David Christopher Turner, Otley (GB); Francisco Fernández Castaño, Utrecht (NL)

(21) Appl. No.: 17/553,465

(22) Filed: Dec. 16, 2021

(51) Int. Cl. G06F 11/14

(52) U.S. Cl. CPC G06F 11/1469

(57) ABSTRACT

Provided are methods and systems for peer recovery from remote storage. An example method includes storing, to a remote storage, a data snapshot of a plurality of nodes of a cluster, determining, by the cluster, that a piece of data stored on a first node of the cluster needs to be copied to a second node of the cluster, and in response to the determination, causing, by the cluster, the second node to download a copy of the piece of data from the data snapshot in the remote storage, determining, by the cluster, that the piece of data stored on the first node differs from the copy of the piece of data stored on the data snapshot, and in response to the determination, causing copying of the piece of data directly from the first node to the second node.

### TECHNICAL FIELD

This disclosure relates to data processing. More specifically, this disclosure relates to systems and methods for peer recovery from remote storage.

### BACKGROUND

Replicating data in clusters is widely used in search engines to decrease processing times of queries and to be resilient against losing individual nodes. The cluster may store a primary copy of data and several replicas on different nodes. Each time the data are copied or moved from one node to another node in the cluster, it requires spending both time and memory resources of the nodes, such as central processing unit resources, random access memory resources, input/output port resources, network resources, and the like. This may result in delays of processing of the queries by the nodes.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

According to one example embodiment, a system for peer recovery from remote storage is provided. The system can include a cluster having a plurality of nodes. The system may include a remote storage configured to store a data snapshot of the plurality of nodes of the cluster. The cluster can be configured to determine that a piece of data stored on a first node of the cluster needs to be copied to a second node of the cluster and, in response to the determination, cause the second node to download a copy of the piece of data from the data snapshot stored in the remote storage.

The cluster can be configured to determine that the piece of data stored on the first node differs from the copy of the piece of data stored on the data snapshot in the remote storage. In response to the determination, the cluster may cause copying of the piece of data directly from the first node to the second node. The first node can be designated to store a primary copy of the piece of data on the cluster.

The first node and the second node belong to the same tier of a plurality of tiers. After downloading of the copy of the piece of data to the second node, the cluster can designate the copy of the piece of data as a replica of the piece of data on the cluster. The determining that the piece of data needs to be copied to the second node may include determining that the second node is a newly added node to the cluster and belongs to the same tier as the first node. The determination that the piece of data needs to be copied to the second node of the cluster may also include determining that a third node has been removed from the cluster, where the third node stores a copy of the piece of data and belongs to the same tier as the second node.

The first node and the second node can belong to different tiers of a plurality of tiers. If this is the case, the determination that the piece of data needs to be copied to the second node may include determining that the piece of data has been stored in the first node for longer than a pre-determined time. After downloading the copy of the piece of data, the cluster may designate the copy of the piece of data as a primary copy of the piece of data in the cluster.

According to another example embodiment of the present disclosure, a method for peer recovery from remote storage is provided. The method may include storing, to a remote storage, a data snapshot of a plurality of nodes of a cluster. The method may allow determining, by the cluster, that a piece of data stored on a first node of the cluster needs to be copied to a second node of the cluster. In response to the determination, the method may cause, by the cluster, the second node to download a copy of the piece of data from the data snapshot stored in a remote storage.

According to yet another example embodiment of the present disclosure, the operations of the above-mentioned method for peer recovery from remote storage are stored on a machine-readable medium comprising instructions, which when implemented by one or more processors, perform the recited operations.

Other example embodiments of the disclosure and aspects will become apparent from the following description taken in conjunction with the following drawings.

### BRIEF DESCRIPTION OF DRAWINGS

Exemplary embodiments are illustrated by way of example and not limitation in the figures of the accompanying drawings, in which like references indicate similar elements.

FIG. 1 is a block diagram of an example environment suitable for practicing methods for peer recovery from remote storage as described herein.

FIG. 2 is a schematic diagram illustrating a plurality of ordered tiers of nodes, according to an example embodiment.

FIG. 3 is a block diagram showing an example node in an example cluster, in accordance with various embodiments.

FIG. 4 is a schematic diagram illustrating a process of peer recovery from remote storage, according to some example embodiments.

FIG. 5 is a flow chart of an example method for peer recovery from remote storage, according to some example embodiments.

FIG. 6 is an example computer system that can be used to implement some embodiments of the present disclosure.

### DETAILED DESCRIPTION

The technology disclosed herein is concerned with methods and systems for peer recovery from remote storage. Embodiments of the present disclosure may be implemented in clusters configured to store user data and to process search queries and analytics over the data. The processing of the search queries and analytics can be distributed between computing nodes of the cluster. To implement the distributed processing, the cluster needs to store multiple copies of pieces of data between the computing nodes. Typically, at least one of the nodes stores a primary copy of the piece of data and one or more other nodes store replicas of the primary copy.

The nodes in the cluster can be divided into ordered (or ranked) tiers based on the capacity of the nodes, such as performance of processors, memory, and data storages of the nodes. The nodes having hardware of a higher performance may be assigned a higher tier. The most recent data can be stored in nodes of the highest tier. The data can be moved from nodes of a higher tier to nodes of a lower tier after the age of the data exceeds pre-determined threshold.

The term “peer recovery” shall be construed to mean recovery, by a node in the cluster, a copy of the piece of data, from a primary copy of the piece of the data on a peer. The term “peer” shall be construed to mean another data node that stores the primary copy of the piece of the data. Currently, the recovery is carried out by direct downloading of the primary copy from the peer. However, the direct data transfer between nodes in the cluster may cause delays in processing search queries and analytics.

According to embodiments of the present disclosure, the copies of pieces of data can be backed up to a remote storage. Either a copy (for example, a primary copy) or a replica of the copy can be backed as long as the replica is equivalent to the copy.

Storing the copies remotely may allow computing nodes to download the copies from the remote storage rather than from other computing nodes of the cluster. Because copies need to be replicated on multiple nodes, downloading of the copies from the remote storage may allow decreasing amount of data transfer between the nodes of the cluster during peer recovery or transferring the data from nodes of a higher tier to nodes of a lower tier and allow reducing resource consumption of nodes of the cluster.

Accordingly, embodiments of the present disclosure may allow eliminating delays in processing of the search queries and analytics and eliminating delays in processing of data additions and amendments, saving time resources due to speeding up copying and/or movement of data, providing the ability to continually add new data to nodes, increasing the chances that the copying and/or movement of data is successful, decreasing costs of transferring data between the nodes for life cycling and recovering the data in the cluster, increasing probability of correct recovery of the data, reducing the time to create and recover copies of data and move data, and thereby improving reliability of the cluster.

According to one example embodiment of the present disclosure, a system for data recovery may include a cluster and a remote storage. The cluster may include a plurality of nodes. The plurality of nodes may include a master node. The remote storage can be configured to store a data snapshot of the plurality of nodes of the cluster. The cluster can be configured to determine that a piece of data stored on a first node of the cluster needs to be copied to a second node of the cluster. In response to the determination, the cluster may cause the second node to download a copy of the piece of data from the data snapshot stored in the remote storage.

Referring now to the drawings, various embodiments are described in which like reference numerals represent like parts and assemblies throughout the several views. It should be noted that the reference to various embodiments does not limit the scope of the claims attached hereto. Additionally, any examples outlined in this specification are not intended to be limiting and merely set forth some of the many possible embodiments for the appended claims.

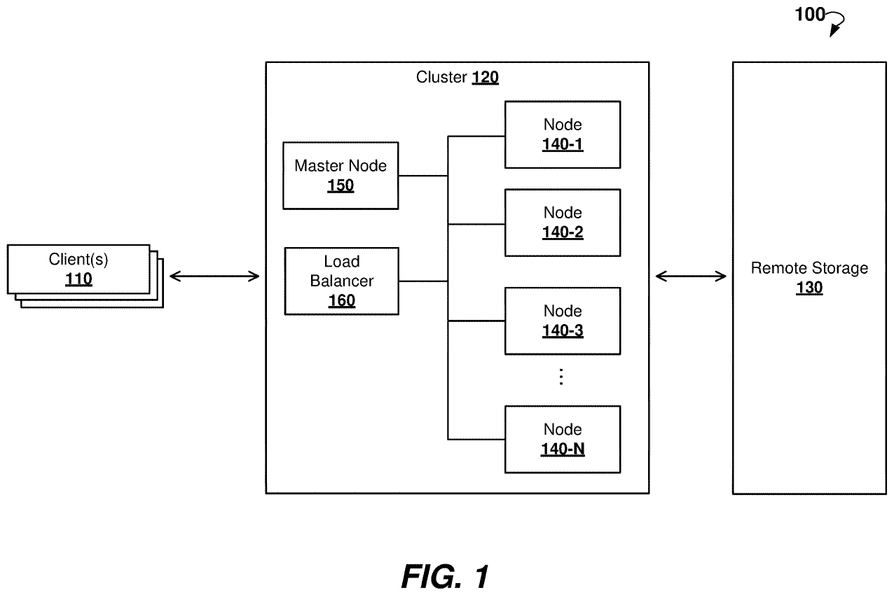

FIG. 1 shows a block diagram of an example environment 100 suitable for practicing methods described herein. It should be noted, however, that the environment 100 is just one example and is a simplified embodiment provided for illustrative purposes, and reasonable deviations of this embodiment are possible as will be evident to those skilled in the art.

As shown in FIG. 1, the environment 100 may include one or more client(s) 110, a cluster 120, and a remote storage 130. In various embodiments, the client(s) 110 may include, but are not limited to, a laptop computer, a tablet computer, a desktop computer, one or more servers, and so forth. The client(s) 110 can include any appropriate device having network functionalities allowing the client(s) 110 to communicate to the cluster 120. In some embodiments, the client(s) 110 can be connected to the cluster 120 via one or more wired or wireless communications networks.

In some embodiments, the cluster 120 may include a load balancer 160 and one or more computing node(s) 140-i (i=1, . . . , N). The cluster 120 may also include a master node 150. The cluster 120 may further include network switches and/or routers for connecting the load balancer 160, the one or more node(s) 140, and the master node 150.

In some embodiments, the computing node(s) 140-i (i=1, . . . , N) may be configured to store data. The node(s) 140-i (i=1, . . . , N) can be configured to execute search queries and analytics over the data as well as accept new data, for example, add or amend data. The search queries can be received from the client(s) 110. The data can be divided in pieces. Each piece of the data can be stored in two of the node(s) 140-i (i=1, . . . , N). One of the computing node(s) 140-i (i=1, . . . , N) may store a primary copy of the piece of data, and one or more of other nodes node(s) 140-i (i=1, . . . , N) each may store a replica of the same piece of the data.

Generally, the user device(s) 110 may send request(s) to the cluster 120. When the cluster 120 receives a request from the one or more client(s) 110, the load balancer 160 may select a node from the one or more computing node(s) 140-i (i=1, . . . , N) to process the request. When selecting the node, the load balancer 160 may distribute the request(s) between the computing nodes 140-i (i=1, . . . , N) based on a load balancing algorithm. The request can be further transferred to the selected node. The selected node can process the request and send a response to the client(s) 110 originating the request.

The remote storage 130 can be configured to store one or more data snapshots of data from the cluster 120. The data snapshot may include at least one primary copy of each piece of data stored in the nodes 140-i (i=1, . . . , N) at a certain time moment. The data from the nodes 140-i (i=1, . . . , N) can be backed up to the remote storage 130 periodically at pre-determined time intervals between two consecutive backups. In some embodiments, the remote storage 130 can be implemented as a cloud-based computing resource (also referred to as a computing cloud). In some embodiments, the cloud-based computing resource may include one or more server farms/clusters comprising a collection of computer servers and is co-located with network switches and/or routers. In various embodiments, the remote storage may include one of the following cluster storages: Amazon S3, Microsoft Azure, and Google cloud storage.

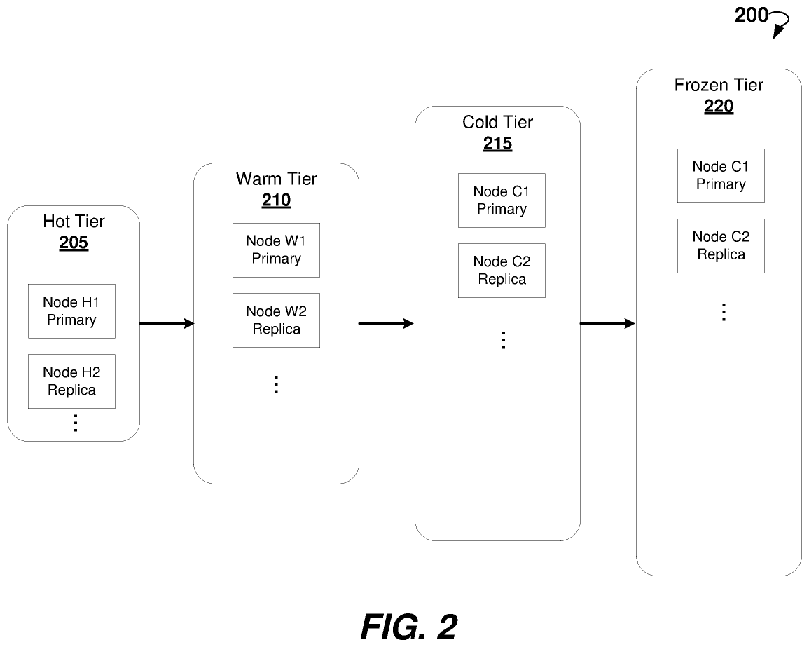

FIG. 2 is a schematic diagram illustrating a plurality of ordered data tiers of nodes, according to an example embodiment. Each of the nodes 140-i (i=1, . . . , N) can be assigned to one of the following tiers: a hot tier 205, a warm tier 210, a cold tier 215, or a frozen tier 220. Nodes having the highest rates and costs of processors, memories, and data storage can be assigned to hot tier 205 (the highest tier). Nodes having the lowest rates and costs of processors, memories, and data storage can be assigned to frozen tier (the lowest tier). In some embodiment, data corresponding to the frozen tier 220 may be stored in a data snapshot on the remote storage 130.

The location data in the tiers can be based on a lifecycle and age of the data. A piece of data stored on nodes corresponding to a higher tier can be moved to nodes of a lower tier when the lifecycle of the piece of the data expires or the age of the piece of data exceeds a pre-determined period of time. The age of the piece of the data can be counted from a time when the piece of data was recorded on a node corresponding to the hot tier.

In some embodiments, a primary copy of each piece of data and at least one replica of the piece of data can be stored in different nodes of the same data tier until the piece of data is moved to a lower tier. In some example embodiments, the cold tier 215 and the frozen tier 220 can be run without replicas.

The cluster 120 shown in FIG. 1 may keep records of distribution of primary copies and replicas of the pieces of data between the nodes and control by moving or copying the primary copies and replicas between nodes of the same tiers or between nodes of different tiers. In some embodiments, the records can be stored on the master node 150.

In some embodiments, the cluster 120 may track lifecycles and ages of pieces of data to determine whether the pieces of data need to be moved from a higher tier to a lower tier. In these embodiments, the cluster 120 may configure the first node of the lower tier to download a copy of the piece of data from a snapshot on the remote storage 130. After the copy has been downloaded to the first node, the cluster 120 may designate this copy as a primary copy of the piece of data in the cluster. The cluster 120 may configure the second node of the lower tier to download the copy of the piece of data from the snapshot on the remote storage 130. After the copy has been downloaded to the first node, the cluster 120 may designate this copy of the piece of data on the second node as replica of the piece of data in the cluster. After, the primary copy and replicas of the piece of data has been established in nodes of the lower tier, the cluster 120 may delete the primary copy and replicas of the piece of data form nodes of the higher tier.

The cluster 120 may receive indications, for example, based on an administrator input, that a new node has been added to the cluster and the new node needs to have a copy of the piece of data. In these embodiments, instead of copying the piece of data from another node in the cluster 120, the new node may download the copy of the piece of data from the snapshot on the remote storage 130.

The cluster 120 may receive indications, for example, based on administrator's input or by pinging the nodes, that a node is either removed from the cluster or is shut down, that is became unavailable. Then the cluster 120 may instruct one or more other nodes to create replicas of data stored on the unavailable node. In these embodiments, instead of copying a primary copy of the piece of data from another node on the cluster 120, the cluster 120 may cause the one or more other nodes to download the primary copy of the piece of data from the snapshot in the remote storage 130.

In some embodiments, prior to downloading of the copy of the piece of data from the snapshot to the remote storage 130, the cluster 120 may check whether the copy of the piece of data in the snapshot is the same as or equivalent to the primary copy of the piece of data in the cluster. If the copy on the snapshot differs from the primary copy in the cluster, the copy of the piece of data is downloaded directly from a node storing the primary copy.

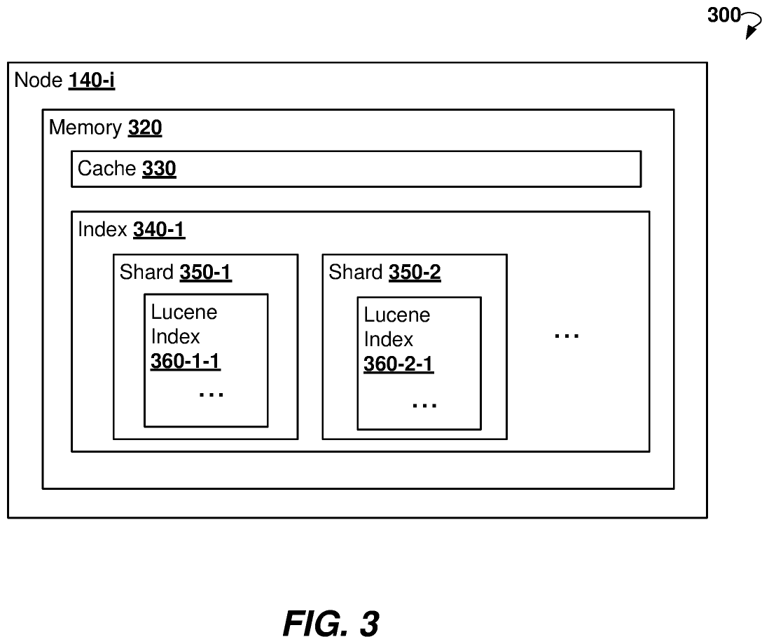

FIG. 3 is a block diagram showing an example computing node 140-i, in accordance with various embodiments. The node 140-i can include memory 320. The memory 320 may include main memory and mass data storage. Memory 320 can store cache 330. An index 340-1 may be stored on the mass data storage. The index 340-1 can be defined as user data processed for searching based on user data properties and types. The user data may include documents, emails, metrics, logs of operational systems of user devices, and so forth.

The index 340-1 can be divided into shards 350-j, each of the shards 350-j can be further divided into Lucene indices 360-i-k. Each shard 350-j can be a fully functional and independent “index” that can be hosted on any of the computing node(s) 140-i (i=1, . . . , N). Shards can be both a physical and logical division of the index 340-1. Lucene is an information retrieval software library. Lucene index may include one or more entities from the data. In some embodiments, the shards can be the pieces of the data that are stored in nodes using primary copies and replicas.

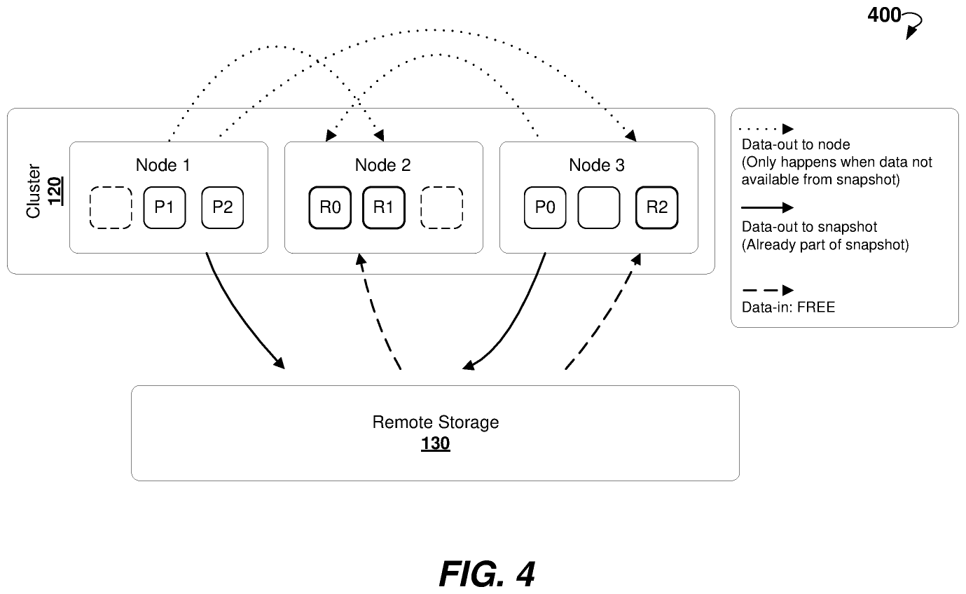

FIG. 4 is a schematic diagram illustrating a scheme 400 of peer recovery from remote storage, according to some example embodiments. In example of FIG. 4, the cluster 120 includes node 1, node 2, and node 3. The node 3 stores a primary copy P0 of the first piece of data (e.g., the first shard). The node 1 stores a primary copy P1 of the second piece of data (e.g., the second shard) and a primary copy P2 of the third piece of data (e.g., the third shard). The primary copy P0, the primary copy P1, and the primary copy P2 are backed up to a snapshot in the remote storage 130.

If the cluster 120 receives a request to create a replica of primary copy P2 on the node 3, then, instead of downloading the primary copy P2 directly from the node 1, the cluster 120 may instruct the node 3 to download the copy P2 from the snapshot. Similarly, if the cluster 120 receives a request to create a replica of primary copy P1 on the node 2, then, instead of downloading the primary copy P1 directly from the node 1, the cluster 120 may instruct the node 3 to download the copy P2 from the snapshot. This allows decreasing loads due to reading data on the nodes 1 and 2, so the resource consumption by the nodes 1 and 2 may be reduced.

The direct downloading of a primary copy from one node of the cluster 120 to another node of the cluster 120 can be required only if the primary copy is not available in the snapshot on the remote storage 130 or the primary copy in the snapshot differs from the primary copy in the cluster.

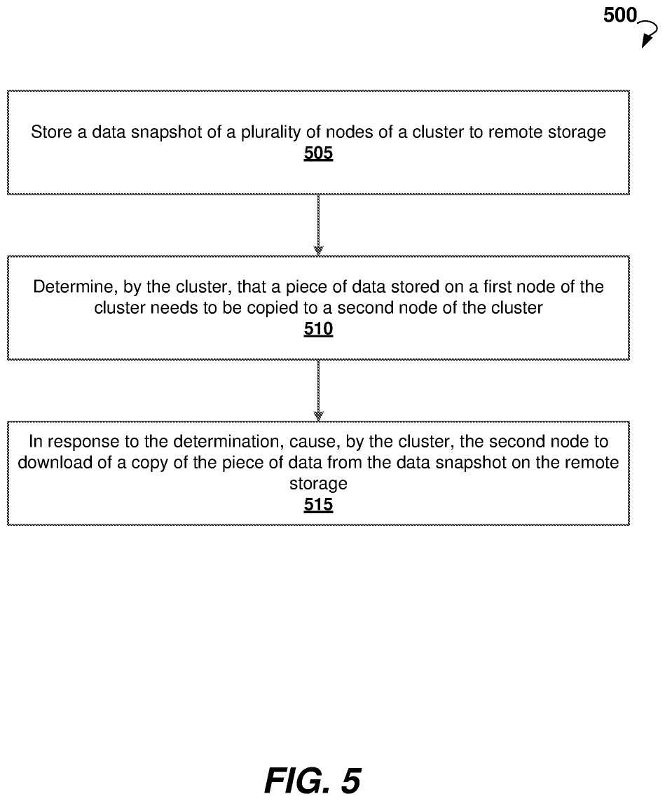

FIG. 5 is a flow chart of an example method 500 for peer recovery from remote storage, according to some example embodiments. The method 500 may be performed within environment 100 illustrated in FIG. 1. Notably, the method 500 may have additional steps not shown herein, but which can be evident to those skilled in the art from the present disclosure.

In block 505, the method 500 may commence with storing, to a remote storage, a data snapshot of a plurality of nodes of a cluster. The plurality of nodes may include a master node.

In block 510, the method 500 may proceed with determining, by the cluster, that a piece of data stored on a first node of the cluster needs to be copied to a second node of the cluster. The first node is designated to store a primary copy of the piece of data on the cluster. The first node and the second node may belong to the same tier of a plurality of tiers. Alternatively, the first node and the second node belong to different tiers of a plurality of tiers.

In block 515, the method 500 may proceed with causing, by the cluster, the second node to download a copy of the piece of data from the data snapshot in the remote storage. In the embodiments with the first node and the second node belonging to the same tier of a plurality of tiers, the determination that the piece of data needs to be copied to the second node may include determining that the second node is a newly added node to the cluster and belongs to the same tier as the first node. In these embodiments, the determination that the piece of data needs to be copied to the second node of the cluster may also include determining that a third node has been removed from the cluster, with the third node storing a copy of the piece of data and belonging to the same tier as the second node. After downloading the copy of the piece of data to the second node, the cluster may designate the copy of the piece of data as a replica of the piece of data in the cluster.

In the embodiments with the first node and the second node belonging to different tiers of a plurality of tiers, the determination that the piece of data needs to be copied to the second node may include determining that the piece of data has been stored in the first node for longer than a pre-determined time.

The method 500 may include determining, by the cluster, that the piece of data stored on the first node differs from the copy of the piece of data stored on the data snapshot in the remote storage. In an example embodiment, pieces of data can differ in two ways. First, a byte-by-byte comparison can reveal some differences between the piece of data stored on the first node and the copy of the piece of data stored on the data snapshot on the remote storage. Second, a semantic difference can be revealed, i.e., the pieces of data can contain different data. The pieces of data can be equivalent in two ways: a) byte-by-byte identical (physically equivalent); 2) semantically equivalent by containing the same data, but stored in a way where the resulting files are not byte-by-byte identical (logically equivalent).

The method 500 may include, in response to the determination, causing, by the cluster, copying of the piece of data directly from the first node to the second node. In some example embodiments, upon determining that the data pieces differ, a snapshot that has some files with byte-by-byte identical data can be considered and used for a partial download of data from the snapshot.

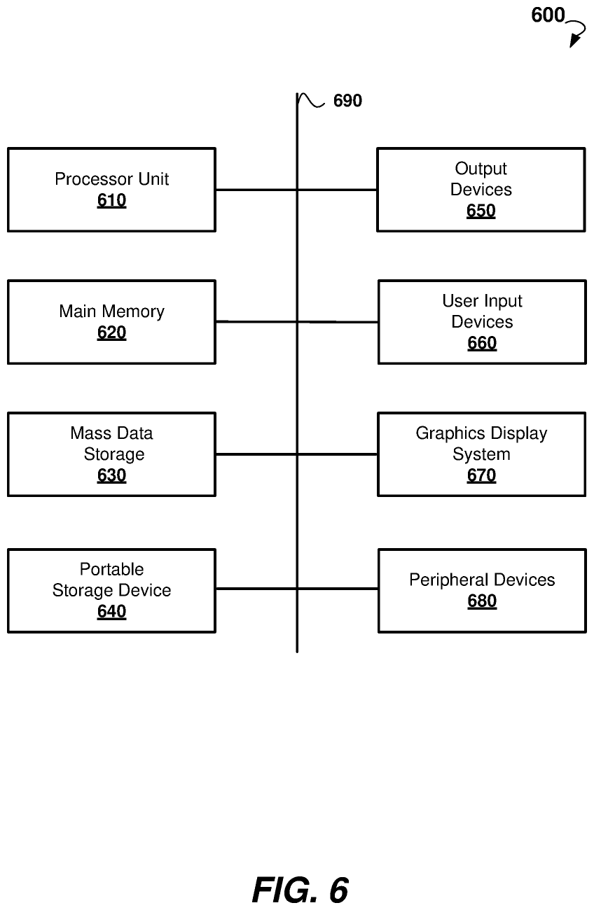

FIG. 6 illustrates an exemplary computer system 600 that may be used to implement some embodiments of the present disclosure. The computer system 600 of FIG. 6 may be implemented in the contexts of the likes of client(s) 110, a cluster 120, a load balancer 160, one or more computing node(s) 140-i (i=1, . . . , N), a master node 150, and a remote storage 130 shown in FIG. 1. The computer system 600 of FIG. 6 includes one or more processor units 610 and main memory 620. Main memory 620 stores, in part, instructions and data for execution by processor units 610. Main memory 620 stores the executable code when in operation, in this example. The computer system 600 of FIG. 6 further includes a mass data storage 630, portable storage device 640, output devices 650, user input devices 660, a graphics display system 670, and peripheral devices 680.

The components shown in FIG. 6 are depicted as being connected via a single bus 690. The components may be connected through one or more data transport means. Processor unit 610 and main memory 620 are connected via a local microprocessor bus, and the mass data storage 630, peripheral device(s) 680, portable storage device 640, and graphics display system 470 are connected via one or more input/output (I/O) buses.

Mass data storage 630, which can be implemented, for example, with a magnetic disk drive, solid state drive, or an optical disk drive, is a non-volatile storage device for storing data and instructions for use by processor unit 610. Mass data storage 630 stores the system software for implementing embodiments of the present disclosure for purposes of loading that software into main memory 620.

In example embodiments, the system software for implementing embodiments of the present disclosure may be input into the computer system 600 through any means possible on a server, i.e., the system software can be downloaded via Internet, pre-installed, stored on a network-attached storage, and so forth.

Portable storage device 640 operates in conjunction with a portable non-volatile storage medium, such as a flash drive, floppy disk, compact disk, digital video disc, or Universal Serial Bus (USB) storage device, to input and output data and code to and from the computer system 600 of FIG. 6. In some example embodiments, the system software for implementing embodiments of the present disclosure can be stored on such a portable medium and input to the computer system 600 via the portable storage device 640.

User input devices 660 can provide a portion of a user interface. User input devices 660 may include one or more microphones; an alphanumeric keypad, such as a keyboard, for inputting alphanumeric and other information; or a pointing device, such as a mouse, a trackball, stylus, or cursor direction keys. User input devices 660 can also include a touchscreen. Additionally, the computer system 600 as shown in FIG. 6 includes output devices 650. Suitable output devices 650 include speakers, printers, network interfaces, and monitors.

Graphics display system 670 can include a liquid crystal display (LCD) or other suitable display device. Graphics display system 670 is configurable to receive textual and graphical information and process the information for output to the display device.

Peripheral devices 680 may include any type of computer support device to add additional functionality to the computer system.

The components provided in the computer system 600 of FIG. 6 are those typically found in computer systems that may be suitable for use with embodiments of the present disclosure and are intended to represent a broad category of such computer components that are well known in the art. Thus, the computer system 600 of FIG. 6 can be a personal computer (PC), handheld computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX, ANDROID, IOS, CHROME, TIZEN, and other suitable operating systems.

The processing for various embodiments may be implemented in software that is cloud-based. In some embodiments, the computer system 600 is implemented as a cloud-based computing environment, such as a virtual machine operating within a computing cloud. In other embodiments, the computer system 600 may itself include a cloud-based computing environment, where the functionalities of the computer system 600 are executed in a distributed fashion. Thus, the computer system 600, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 600, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A system for data recovery, the system comprising:
a cluster including a plurality of nodes; and
a remote storage configured to store a data snapshot of the plurality of nodes of the cluster, wherein:
the cluster is configured to:
determine that a piece of data stored on a first node of the cluster needs to be copied to a second node of the cluster; and
in response to the determination, cause the second node to download a copy of the piece of data from the data snapshot stored in the remote storage.

2. The system of claim 1, wherein the cluster is configured to:
determine that the piece of data stored on the first node differs from the copy of the piece of data stored on the data snapshot in the remote storage; and
in response to the determination, cause copying of the piece of data directly from the first node to the second node.

3. The system of claim 1, wherein the first node is designated to store a primary copy of the piece of data on the cluster.

4. The system of claim 1, wherein the first node and the second node belong to the same tier of a plurality of tiers.

5. The system of claim 4, wherein, after downloading the copy of the piece of data to the second node, the cluster designates the copy of the piece of data as a replica of the piece of data on the cluster.

6. The system of claim 4, wherein the determining that the piece of data needs to be copied to the second node includes determining that the second node is a newly added node to the cluster and belongs to the same tier as the first node.

7. The system of claim 4, wherein the determining that the piece of data needs to be copied to the second node of the cluster includes determining that a third node has been removed from the cluster, the third node storing a copy of the piece of data and belonging to the same tier as the second node.

8. The system of claim 1, wherein the first node and the second node belong to different tiers of a plurality of tiers.

9. The system of claim 8, wherein the determining that the piece of data needs to be copied to the second node includes determining that the piece of data has been stored in the first node for longer than a pre-determined time.

10. The system of claim 8, wherein after downloading the copy of the piece of data, the cluster designates the copy of the piece of data as a primary copy of the piece of data in the cluster.

11. A method for data recovery, the method comprising:
storing, to a remote storage, a data snapshot of a plurality of nodes of a cluster;
determining, by the cluster, that a piece of data stored on a first node of the cluster needs to be copied to a second node of the cluster; and
in response to the determination, causing, by the cluster, the second node to download a copy of the piece of data from the data snapshot in the remote storage.

12. The method of claim 11, further comprising:
determining, by the cluster, that the piece of data stored on the first node differs from the copy of the piece of data stored on the data snapshot in the remote storage; and
in response to the determination, causing, by the cluster, copying of the piece of data directly from the first node to the second node.

13. The method of claim 11, wherein the first node is designated to store a primary copy of the piece of data on the cluster.

14. The method of claim 11, wherein the first node and the second node belong to the same tier of a plurality of tiers.

15. The method of claim 14, further comprising, after downloading the copy of the piece of data to the second node, designating, by the cluster, the copy of the piece of data as a replica of the piece of data in the cluster.

16. The method of claim 14, wherein the determining that the piece of data needs to be copied to the second node includes determining that the second node is a newly added node to the cluster and belongs to the same tier as the first node.

17. The method of claim 14, wherein the determining that the piece of data needs to be copied to the second node of the cluster includes determining that a third node has been removed from the cluster, the third node storing a copy of the piece of data and belonging to the same tier as the second node.

18. The method of claim 11, wherein the first node and the second node belong to different tiers of a plurality of tiers.

19. The method of claim 18, wherein the determining that the piece of data needs to be copied to the second node includes determining that the piece of data has been stored in the first node for longer than a pre-determined time.

20. A non-transitory computer-readable storage medium having embodied thereon instructions, which when executed by at least one processor, perform steps of a method, the method comprising:
storing, to a remote storage, a data snapshot of a plurality of nodes of a cluster;
determining, by the cluster, that a piece of data stored on a first node of the cluster needs to be copied to a second node of the cluster; and
in response to the determination, causing, by the cluster, the second node to download a copy of the piece of data from the data snapshot stored in a remote storage.
